(19) United States
(12) Patent Application Publication
(10) Pub. No.: US 2025/0242809 A1
(43) Pub. Date: Jul. 31, 2025

(54) SYSTEMS AND METHODS FOR CONTROLLING A VEHICLE USING PHYSIOLOGICAL DATA OF A DRIVER OF THE VEHICLE

(71) Applicant: Toyota Motor Engineering & Manufacturing North America, Inc., Plano, TX (US)

(72) Inventors: Rohit Gupta, Santa Clara, CA (US); Amr Abdelraouf, Redwood City, CA (US); Kyungtae Han, Palo Alto, CA (US); Shili Sheng, Charlottesville, VA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/424,131

(22) Filed: Jan. 26, 2024

(51) Int. Cl. B60W 30/16; B60W 50/14; G06F 3/01

(52) U.S. Cl. CPC B60W 30/16; B60W 50/14; G06F 3/015; B60W 2050/146; B60W 2510/18; B60W 2520/06; B60W 2520/10; B60W 2520/105; B60W 2540/221; B60W 2554/4041; B60W 2754/30

(57) ABSTRACT

A system includes a controller configured to train a model for predicting a preferred distance between a vehicle and a preceding vehicle using a training data set including physiological data of a driver and information on a status of the vehicle, input current physiological data of the driver and information on a current status of the vehicle to the trained model to obtain a current preferred distance, and control the vehicle to adjust a distance between the vehicle and the preceding vehicle based on the current preferred distance.

### TECHNICAL FIELD

The present disclosure relates to systems and methods for controlling a vehicle using physiological data of a driver of the vehicle.

### BACKGROUND

Accurately controlling a vehicle for adjusting a distance between the vehicle and a preceding vehicle may be desired for many reasons. However, a desired distance between the vehicle and the preceding vehicle may vary from diverse drivers of the vehicle. Moreover, the same driver may have a different desired distance based on a condition of the driver. Thus, it may be challenging to control a distance between the vehicle and the preceding vehicle based on the preference of each driver.

Accordingly, a need exists for systems and methods that accurately control the vehicle to adjust the distance between the vehicle and the preceding vehicle for each drivers of the vehicle.

### SUMMARY

The present disclosure provides systems and methods for controlling a vehicle using physiological data of a driver of the vehicle. Using physiological data of the driver of the vehicle and information on a status of the vehicle, the systems and methods may train a model for predicting a preferred distance between the vehicle and the preceding vehicle. The systems and methods may obtain a current preferred distance based on current physiological data of the driver and information on a current status of the vehicle. Based on the obtained current preferred distance, the systems and methods may accurately control the vehicle to adjust a distance between the vehicle and the preceding vehicle, thereby avoiding an undesirable situation.

In one or more embodiments, a system includes a controller configured to train a model for predicting a preferred distance between a vehicle and a preceding vehicle using a training data set including physiological data of a driver and information on a status of the vehicle, input current physiological data of the driver and information on a current status of the vehicle to the trained model to obtain a current preferred distance, and control the vehicle to adjust a distance between the vehicle and the preceding vehicle based on the current preferred distance.

In another embodiment, a method comprising training a model for predicting a preferred distance between a vehicle and a preceding vehicle using a training data set including physiological data of a driver and information on a status of the vehicle, inputting current physiological data of the driver and information on a current status of the vehicle to the trained model to obtain a current preferred distance, and controlling the vehicle to adjust a distance between the vehicle and the preceding vehicle based on the current preferred distance.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A schematically depicts an exemplary embodiment of for controlling a vehicle using physiological data of a driver of the vehicle, according to one or more embodiments shown and described herein;

FIG. 1B graphically depicts an actual distance D1 between the vehicle and the preceding vehicle and a prediction of a current preferred distance PD1 (y-axis) as a function of time (x-axis) for controlling the vehicle, according to one or more embodiments shown and described herein;

FIG. 2 depicts a schematic diagram of a system for controlling a vehicle using physiological data of a driver of the vehicle, according to one or more embodiments shown and described herein;

FIG. 3 depicts a flowchart for a method of for controlling a vehicle using physiological data of a driver of the vehicle request, according to one or more embodiments shown and described herein; and

FIG. 4 depicts a flowchart for a method of for controlling a vehicle using physiological data of a driver of the vehicle request, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include systems and methods for controlling a vehicle using physiological data of a driver of the vehicle. Using physiological data of the driver of the vehicle and information on a status of the vehicle, the systems and methods may train a model for predicting a preferred distance between the vehicle and the preceding vehicle. The systems and methods may obtain a current preferred distance based on current physiological data of the driver and information on a current status of the vehicle. Based on the obtained current preferred distance, the systems and methods may accurately control the vehicle to adjust a distance between the vehicle and the preceding vehicle, thereby avoiding an undesirable situation.

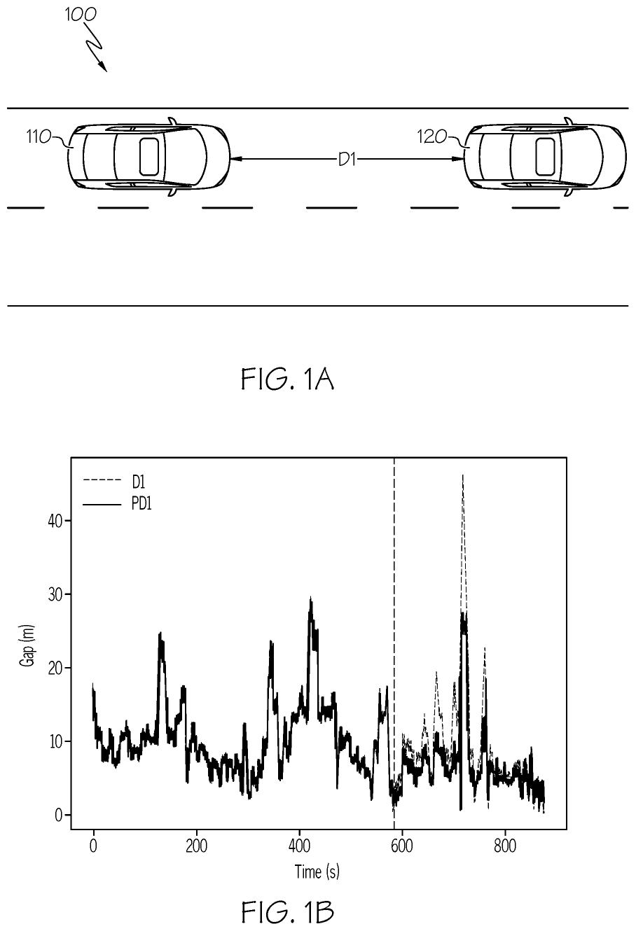

FIG. 1A schematically depicts an exemplary embodiment of for controlling a vehicle using physiological data of a driver of the vehicle, according to one or more embodiments shown and described herein. FIG. 1B graphically depicts an actual distance D1 between the vehicle and the preceding vehicle and a prediction of a current preferred distance PD1 (y-axis) as a function of time (x-axis) for controlling the vehicle, according to one or more embodiments shown and described herein.

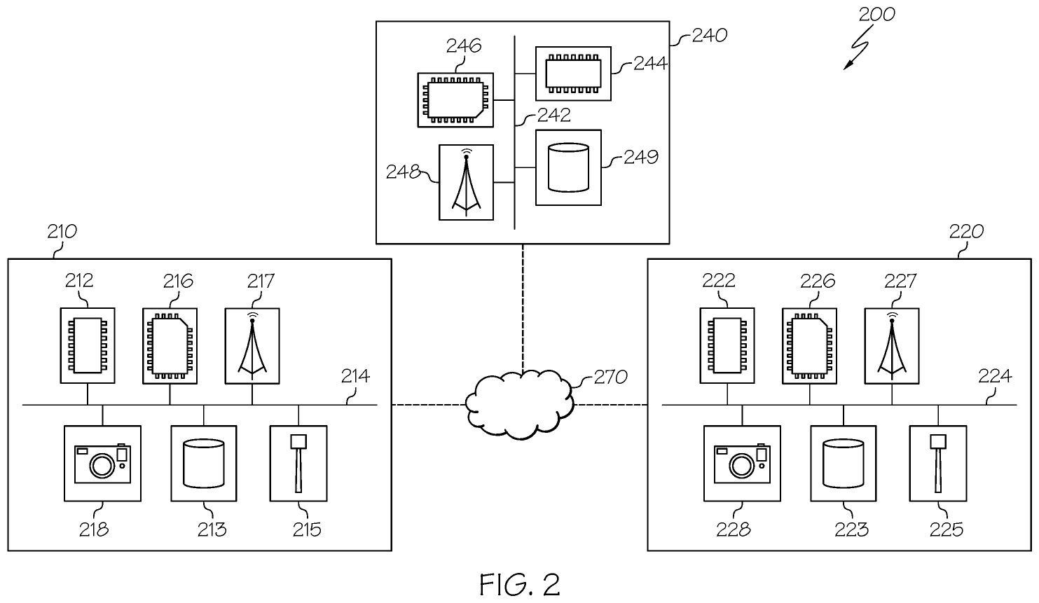

Referring to FIGS. 1A and 1B, the system 100 includes a vehicle 110 and a preceding vehicle 120. The vehicle 110, the preceding vehicle 120, or both, may be a vehicle including an automobile or any other passenger or non-passenger vehicle such as, for example, a terrestrial, aquatic, and/or airborne vehicle. In some embodiments, the vehicle 110, the preceding vehicle 120, or both, may be an autonomous driving vehicle or semi-autonomous driving vehicle. For example, the vehicle 110, the preceding vehicle 120, or both, may be vehicles with SAE level 3 or more autonomy. The vehicle 110, the preceding vehicle 120, or both, may be an autonomous vehicle that navigates its environment with limited human input or without human input. The vehicle 110, the preceding vehicle 120, or both, may be equipped with internet access and share data with other devices both inside and outside the vehicle 110, the preceding vehicle 120, or both. The vehicle 110, the preceding vehicle 120, or both may communicate with the server 240 (shown in FIG. 2) and transmit its data to the server 240 (shown in FIG. 2). For example, the vehicle 110, the preceding vehicle 120, or both, transmits information about its current location and destination, its environment, information about a current driver including physiological data of a current driver, identification of a current driver, or both, information about a task that it is currently implementing, and the like. The vehicle 110, the preceding vehicle 120, or both, may include an actuator configured to move the vehicle 110, the preceding vehicle 120, or both.

The vehicle 110 may train a model for predicting a preferred distance between the vehicle 110 and the preceding vehicle 120 using a training data set including physiological data of the driver of the vehicle 110, information on a status of the vehicle 110, and a distance between the vehicle 110 and the preceding vehicle 120. In one or more embodiments, the model may comprise a machine learning model. In one or more embodiments, the machine learning model may be an Artificial Neural Network (ANN), such as recurrent neural network (RNN), a convolutional neural network, a Deep Neural Network (DNN), or combinations thereof, which may be trained using ground-truth data. The ground-truth data may be an actual distance between the vehicle 110 and preceding vehicle 120. The model may be trained to minimize the difference between an actual distance (current distance) D1 and a current preferred distance PD1. In some embodiments, the machine learning model may employ other types of supervised machine learning algorithms, such as regression models, classifiers, or the like. In one or more embodiments, the model may be a long-short term model. A long-short term model or a long short-term memory may be a variation of an RNN model. While the RNN model may only memorize short-term information, but the long-short term model may handle long time-series data. Moreover, an RNN model has the vanishing gradient problem for the long sequence data; however, the long-short term model may prevent this problem during training. An LSTM model may recall previous long-term time-series data and have automatic control for retaining relevant features or discarding irrelevant features in the cell state. The LSTM model may include three gates to control features, that is, the input gate, forget gate, and output gate. The input gate may control new information to flow into the cell state. The forget gate may remove previous unimportant information from the cell state. The output gate may regulate extracted information from the cell state and then decides the next hidden state. The long-short term model may automatically save or remove stored memory using these gates.

In one or more embodiments, the model may be trained while the vehicle 110 is in a driving simulation mode. The simulation mode may provide an opportunity to reproduce characteristics of the vehicle 110, such as size, color, velocity, acceleration, or combinations thereof, in a virtual environment. In some embodiments, the model may be trained while the vehicle 110 is driving, while the vehicle 110 is in driving simulation mode, or both. When the model is trained while the vehicle 110 is in driving simulation mode, the training data set may include physiological data of drivers of the vehicle 110 while the vehicle 110 is in driving simulation mode, and information on a status of the vehicle 110 while the vehicle 110 is in driving simulation mode. In one or more embodiments, when the model is trained while the vehicle 110 is driving, the training data set may include physiological data of drivers of the vehicle 110 while the vehicle 110 is driving, and information on a status of the vehicle 110 while the vehicle 110 is driving. In some embodiments, the model may be trained using real-time data while the vehicle 110 is driving. The real-time data may include real-time physiological data of the driver of the vehicle 110 and information on the real-time status of the vehicle 110.

While the vehicle 110 is in driving simulation mode, the vehicle 110 is driving, or both, the model may obtain characteristics of driving behavior of the driver of the vehicle 110. The driving behavior may refer intentional and unintentional characteristics and action the driver performs while operating the vehicle 110. The driving behavior may include driver head rotation, eye-gaze dynamics, hand motion and gestures, body movement, and foot dynamics, or combinations thereof. Many factors may contribute to or alter the driver's behavior such as age, experience, gender, attitude, emotions, fatigue, drowsiness, driving conditions, or combinations thereof. The model is trained to provide personalized adaptive cruise control, automatic cruise control, activating autonomous driving capabilities, or combinations thereof, to the driver to control the vehicle 110.

In one or more embodiments, the physiological data of the driver of the vehicle 110 may include temperature of the driver, electrocardiogram (ECG) data of the driver, galvanic skin response (GSR) data of the driver, face recognition data of the driver, iris recognition data of the driver, or combinations thereof. In some embodiments, the physiological data of the driver of the vehicle 110 may be obtained while the driver of the vehicle 110 is driving the vehicle, in real time, or both. The physiological data of the driver of the vehicle 110 may be obtained by sensors in the vehicle 110. The sensors in the vehicle 110 may be located on the roof, the navigation devices, handles, windows, windshield, or combinations thereof. The sensors may include GSR sensors worn by the driver, ECG sensors worn by the driver, temperature sensors of the vehicle 110, image sensors of the vehicle 110, sound sensors of the vehicle 110, display devices of the driver of the vehicle 110, or combinations thereof. The display device may include a navigation device, a smartphone, a smartwatch, a laptop, a tablet computer, a personal computer, a wearable device, or combinations thereof.

In one or more embodiments, the driver of the vehicle 110 may wear a wearable device to obtain the physiological data of the driver of the vehicle 110. The wearable device may include a fitness tracker, a smart watch, a smart ring, a smart clothing, smart glasses, a wearable ECG monitor, a biosensor, smart earbuds, smart jewelry, a smart belt, or combinations thereof.

In one or more embodiments, the status of the vehicle 110 may include a status of throttle of the vehicle 110, a status of a brake of the vehicle 110, a velocity of the vehicle 110, an acceleration of the vehicle 110, the driving direction of the vehicle 110, environments, such as weather, road surface conditions, traffic signs, other surroundings of the vehicle 110, a distance between the vehicle 110 and the preceding vehicle 120, or combinations thereof. The information on the status of the vehicle 110 may be obtained by the image sensors, sounds sensors, display devices, or combinations thereof. In some embodiments, the image sensors may include one or more LIDAR sensors, radar sensors, sonar sensors, or other types of sensors for gathering data that could be integrated into or supplement the data collection. Ranging sensors like radar sensors may be used to obtain rough depth and speed information for the view of the vehicle 110.

The vehicle 110 may input current physiological data of the driver and information on a current status of the vehicle 110 to a trained machine learning model to obtain a current preferred distance PD1. The current preferred distance PD1 refers to a preferred distance between the vehicle 110 and the preceding vehicle 120 in the near future, e.g., in the next one second.

In one or more embodiments, the vehicle 110 may determine whether the current preferred distance PD1 meets safety requirements and/or satisfaction requirements. The vehicle 110 may compare the current preferred distance PD1 to a predetermined distance. For example, the predetermined distance may be a minimum safety distance between two vehicles required by law. As another example, the predetermined distance may be a minimum distance that satisfies the satisfaction of the driver. The predetermined distance may be determined based on a preference of the driver of the vehicle 110, a current status of the driver of the vehicle 110, environment of the vehicle 110, status of surrounding vehicles of the vehicle 110, traffic around the vehicle 110, road condition around the vehicle 110, or combinations thereof.

The vehicle 110 may control the vehicle 110 to adjust a distance D1 between the vehicle 110 and the preceding vehicle 120 based on the current preferred distance PD1. In one or more embodiments, the vehicle 110 is controlled by adaptive cruise control, automatic cruise control, activating autonomous driving capabilities, or combinations thereof.

In one or more embodiments, in response to determining that the current preferred distance PD1 between the vehicle 110 and the preceding vehicle 120 is less than the predetermined distance, the vehicle 110 may control the vehicle 110 to increase the current distance D1 between the vehicle 110 and the preceding vehicle 120 greater than or equal to the predetermined distance. In response to determining that the current preferred distance PD1 between the vehicle 110 and the preceding vehicle 120 is less than the predetermined distance, the vehicle 110 may generate an alarm to the driver of the vehicle 110. In some embodiments, the vehicle 110 may generate an alarm on the display devices of the driver of the vehicle 110.

In one or more embodiments, in response to determining that the current preferred distance PD1 between the vehicle and the preceding vehicle 120 is greater than or equal to the predetermined distance, the vehicle 110 may control the vehicle 110 to maintain the current distance D1 between the vehicle 110 and the preceding vehicle 120.

The vehicle 110 may display the current preferred distance PD1 between the vehicle 110 and the preceding vehicle 120 and the current distance D1 between the vehicle 110 and the preceding vehicle 120 to the driver of the vehicle 110. In one or more embodiments, the vehicle 110 may display the current preferred distance PD1 between the vehicle 110 and the preceding vehicle 120 and the current distance D1 between the vehicle 110 and the preceding vehicle 120 to the driver of the vehicle 110 on the display devices of the driver of the vehicle 110.

FIG. 2 depicts a schematic diagram of a system for controlling a vehicle using physiological data of a driver of the vehicle, according to one or more embodiments shown and described herein.

Referring to FIG. 2, the system 200 includes a vehicle system 210, a preceding vehicle system 220, and the server 240.

The vehicle system 210 includes one or more processors 212. Each of the one or more processors 212 may be any device capable of executing machine-readable and executable instructions. Each of the one or more processors 212 may be a controller, an integrated circuit, a microchip, a computer, or any other computing device. One or more processors 212 are coupled to a communication path 214 that provides signal interconnectivity between various modules of the system. The communication path 214 may communicatively couple any number of processors 212 with one another, and allow the modules coupled to the communication path 214 to operate in a distributed computing environment. Each of the modules may operate as a node that may send and/or receive data. As used herein, the term “communicatively coupled” means that coupled components are capable of exchanging data signals with one another such as electrical signals via a conductive medium, electromagnetic signals via air, optical signals via optical waveguides, and the like.

In one or more embodiments, one or more processors 212 may train a model for predicting a preferred distance between the vehicle system 210 and the preceding vehicle system 220 using a training data set including physiological data of the driver of the vehicle system 210 and information on a status of the vehicle system 210.

The communication path 214 may be formed from any medium that is capable of transmitting a signal such as conductive wires, conductive traces, optical waveguides, or the like. In some embodiments, the communication path 214 may facilitate the transmission of wireless signals, such as WiFi, Bluetooth®, Near Field Communication (NFC), and the like. The communication path 214 may be formed from a combination of mediums capable of transmitting signals. In one embodiment, the communication path 214 comprises a combination of conductive traces, conductive wires, connectors, and buses that cooperate to permit the transmission of electrical data signals to components such as processors, memories, sensors, input devices, output devices, and communication devices. The communication path 214 may comprise a vehicle bus, such as a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The vehicle system 210 includes one or more memory modules 216 coupled to the communication path 214 and may contain non-transitory computer-readable medium comprising RAM, ROM, flash memories, hard drives, or any device capable of storing machine-readable and executable instructions such that the machine-readable and executable instructions can be accessed by the one or more processors 212. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored in the one or more memory modules 216. The machine-readable and executable instructions may be written in a hardware description language (HDL), such as logic implemented via either a field-programmable gate array (FPGA) configuration or an application-specific integrated circuit (ASIC), or their equivalents. The methods described herein may be implemented in any conventional computer programming language, as pre-programmed hardware elements, or as a combination of hardware and software components. The one or more processors 212 along with the one or more memory modules 216 may operate as a controller for the vehicle system 210.

Still referring to FIG. 2, the vehicle system 210 includes one or more sensors 218. One or more sensors 218 may be any device having an array of sensing devices capable of detecting radiation in an ultraviolet wavelength band, a visible light wavelength band, or an infrared wavelength band. One or more sensors 218 may detect the presence of the vehicle system 210, the presence of the preceding vehicle system 220, the location of the vehicle system 210, the location of the preceding vehicle system 220, the distance between the vehicle system 210 and the preceding vehicle system 220. One or more sensors 218 may have any resolution. In some embodiments, one or more optical components, such as a mirror, fish-eye lens, or any other type of lens may be optically coupled to one or more sensors 218. In some embodiments, one or more sensors 218 may provide image data to one or more processors 212 or another component communicatively coupled to the communication path 214. In some embodiments, one or more sensors 218 may provide navigation support. In embodiments, data captured by one or more sensors 218 may be used to autonomously or semi-autonomously navigate the vehicle system 210.

In one or more embodiments, one or more sensors 218 may obtain the physiological data of the driver of the vehicle system 210, the status of the vehicle system 210, or both.

The vehicle system 210 includes a satellite antenna 215 coupled to the communication path 214 such that the communication path 214 communicatively couples the satellite antenna 215 to other modules of the vehicle system 210. The satellite antenna 215 is configured to receive signals from global positioning system satellites. In one embodiment, the satellite antenna 215 includes one or more conductive elements that interact with electromagnetic signals transmitted by global positioning system satellites. The received signal is transformed into a data signal indicative of the location (e.g., latitude and longitude) of the satellite antenna 215 or an object positioned near the satellite antenna 215, by one or more processors 212.

The vehicle system 210 includes one or more vehicle sensors 213. Each of one or more vehicle sensors 213 is coupled to the communication path 214 and communicatively coupled to one or more processors 212. One or more vehicle sensors 213 may include one or more motion sensors for detecting and measuring motion and changes in the motion of the vehicle system 210. The motion sensors may include inertial measurement units. Each of the one or more motion sensors may include one or more accelerometers and one or more gyroscopes. Each of one or more motion sensors transforms sensed physical movement of the vehicle into a signal indicative of an orientation, a rotation, a velocity, or an acceleration of the vehicle. In one or more embodiments, one or more vehicle sensors 213 may obtain the physiological data of the driver of the vehicle system 210, the status of the vehicle system 210, or both.

Still referring to FIG. 2, the vehicle system 210 includes a network interface hardware 217 for communicatively coupling the vehicle system 210 to the server 240. The network interface hardware 217 may be communicatively coupled to the communication path 214 and may be any device capable of transmitting and/or receiving data via a network. The network interface hardware 217 may include a communication transceiver for sending and/or receiving any wired or wireless communication. For example, the network interface hardware 217 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 217 includes hardware configured to operate in accordance with the Bluetooth® wireless communication protocol. The network interface hardware 217 of the vehicle system 210 may transmit its data to the server 240. For example, the network interface hardware 217 of the vehicle system 210 may transmit vehicle data, location data, maneuver data, and the like to the server 240.

The vehicle system 210 may connect with one or more external vehicle systems (e.g., the preceding vehicle system 220) and/or external processing devices (e.g., a cloud server, an edge server, or both) via a direct connection. The direct connection may be a vehicle-to-vehicle connection (“V2V connection”), a vehicle-to-everything connection (“V2X connection”), or an mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure.

Vehicles may function as infrastructure nodes to form a mesh network and connect dynamically on an ad-hoc basis. In this way, vehicles may enter and/or leave the network at will, such that the mesh network may self-organize and self-modify over time. The network may include vehicles forming peer-to-peer networks with other vehicles or utilizing centralized networks that rely upon certain vehicles and/or infrastructure elements. The network may include networks using the centralized server and other central computing devices to store and/or relay information between vehicles.

Still referring to FIG. 2, the vehicle system 210 may be communicatively coupled to the preceding vehicle system 220, the server 240, or both, by the network 270. In one embodiment, the network 270 may include one or more computer networks (e.g., a personal area network, a local area network, or a wide area network), cellular networks, satellite networks and/or a global positioning system and combinations thereof. The vehicle system 210 may be communicatively coupled to the network 270 via a wide area network, a local area network, a personal area network, a cellular network, a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the preceding vehicle system 220 includes one or more processors 222, one or more memory modules 226, one or more sensors 228, one or more device sensors 223, a satellite antenna 225, a network interface hardware 227, and a communication path 224 communicatively connected to the other components of preceding vehicle system 220. The components of the preceding vehicle system 220 may be structurally similar to and have similar functions as the corresponding components of the vehicle system 210 (e.g., the one or more processors 222 correspond to the one or more processors 212, the one or more memory modules 226 correspond to the one or more memory modules 216, the one or more sensors 228 correspond to the one or more sensors 218, the satellite antenna 225 corresponds to the satellite antenna 215, the communication path 224 corresponds to the communication path 214, and the network interface hardware 227 corresponds to the network interface hardware 217).

Still referring to FIG. 2, the server 240 includes one or more processors 244, one or more memory modules 246, a network interface hardware 248, one or more vehicle sensors 249, and a communication path 242 communicatively connected to the other components of the vehicle system 210. The components of the server 240 may be structurally similar to and have similar functions as the corresponding components of the vehicle system 210 (e.g., the one or more processors 244 correspond to the one or more processors 212, the one or more memory modules 246 correspond to the one or more memory modules 216, the one or more vehicle sensors 249 correspond to the one or more vehicle sensors 213, the communication path 242 corresponds to the communication path 214, and the network interface hardware 248 corresponds to the network interface hardware 217).

It should be understood that the components illustrated in FIG. 2 are merely illustrative and are not intended to limit the scope of this disclosure. More specifically, while the components in FIG. 2 are illustrated as residing within the vehicle system 210 the preceding vehicle system 220, or both, this is a non-limiting example. In some embodiments, one or more of the components may reside external to the vehicle system 210, the preceding vehicle system 220, or both, such as with the server 240.

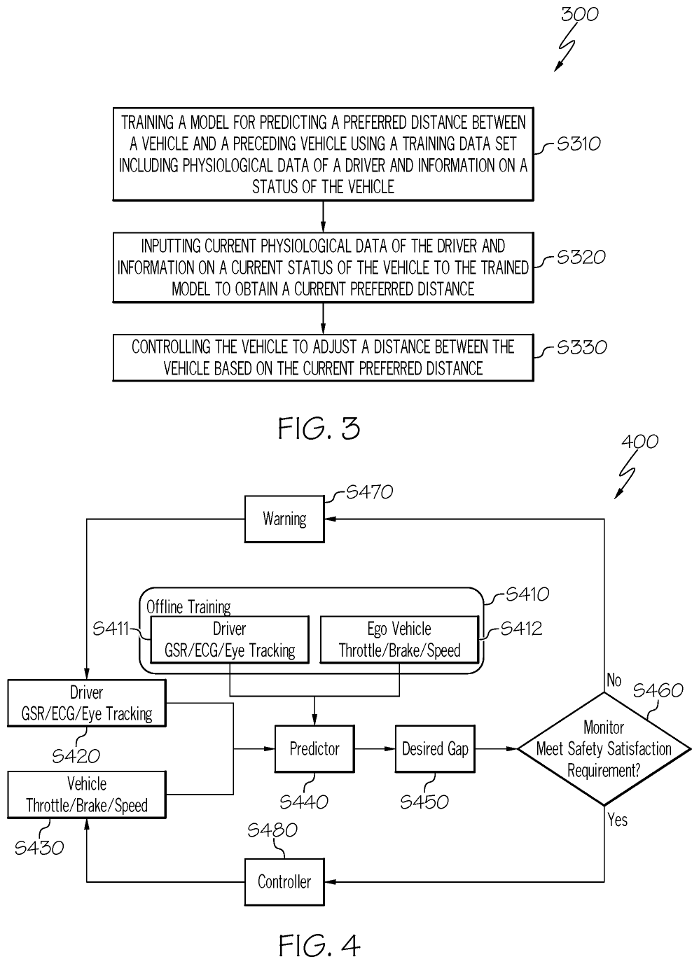

FIG. 3 depicts a flowchart for a method of for controlling a vehicle using physiological data of a driver of the vehicle, according to one or more embodiments shown and described herein. The method 300 may be executed by the system 100 as depicted in FIGS. 1A-1B as described herein. Additionally, the method 300 will be described with reference to the elements depicted in FIGS. 1A, 1B, and 2.

Referring to FIGS. 1A, 1B, 2, and 3, at step S310, a controller, for example, the controller of the vehicle 110 may train a model for predicting a preferred distance between a vehicle 110 and a preceding vehicle 120 using a training data set including physiological data of a driver and information on a status of the vehicle 110. In one or more embodiments, the model may comprise a machine learning model. In one or more embodiments, the model may be a long-short term model.

In one or more embodiments, the model may be trained while the vehicle 110 is in driving simulation mode. In some embodiments, the model may be trained while the vehicle 110 is driving, while the vehicle 110 is in driving simulation mode, or both. When the model is trained while the vehicle 110 is in driving simulation mode, the training data set may include physiological data of drivers of the vehicle 110 while the vehicle 110 is in driving simulation mode, and information on a status of the vehicle 110 while the vehicle 110 is in driving simulation mode. In one or more embodiments, when the model is trained while the vehicle 110 is driving, the training data set may include physiological data of drivers of the vehicle 110 while the vehicle 110 is driving, and information on a status of the vehicle 110 while the vehicle 110 is driving. In some embodiments, the model may be trained using real-time data while the vehicle 110 is driving. The real-time data may include real-time physiological data of the driver of the vehicle 110 and information on the real-time status of the vehicle 110.

Still referring to FIGS. 1A, 1B, 2, and 3, at step S320, the controller may input current physiological data of the driver and information on a current status of the vehicle 110 to obtain a current preferred distance PD1. In one or more embodiments, the controller may compare the current preferred distance PD1 to a predetermined distance.

Still referring to FIGS. 1A, 1B, 2, and 3, at step S330, the controller may control the vehicle 110 to adjust a distance D1 between the vehicle 110 and the preceding vehicle 120 based on the current preferred distance PD1. In one or more embodiments, the vehicle 110 is controlled by adaptive cruise control, automatic cruise control, activating autonomous driving capabilities, or combinations thereof.

In one or more embodiments, in response to determining that the current preferred distance PD1 between the vehicle 110 and the preceding vehicle 120 is less than the predetermined distance, the controller may control the vehicle 110 to increase the current distance D1 between the vehicle 110 and the preceding vehicle 120 greater than or equal to the predetermined distance. In response to determining that the current preferred distance PD1 between the vehicle 110 and the preceding vehicle 120 is less than the predetermined distance, the controller may generate an alarm to the driver of the vehicle 110. In some embodiments, the controller may generate an alarm on the display devices of the driver of the vehicle 110.

In one or more embodiments, in response to determining that the current preferred distance PD1 between the vehicle and the preceding vehicle 120 is greater than or equal to the predetermined distance, the controller may control the vehicle 110 to maintain the current distance D1 between the vehicle 110 and the preceding vehicle 120.

The controller may display the current preferred distance PD1 between the vehicle 110 and the preceding vehicle 120 and the current distance D1 between the vehicle 110 and the preceding vehicle 120 to the driver of the vehicle 110.

FIG. 4 depicts a flowchart for a method of for controlling a vehicle using physiological data of a driver of the vehicle, according to one or more embodiments shown and described herein. The method 400 may be executed by the system 100 as depicted in FIGS. 1A-1B as described herein. Additionally, the method 400 will be described with reference to the elements depicted in FIGS. 1A, 1B, and 2.

Referring to FIGS. 1A, 1B, 2, and 4, at step 410, a controller, for example, while the vehicle 110 is in a driving simulation mode, the controller of the vehicle 110 may train a model for predicting a preferred distance between a vehicle 110 and a preceding vehicle 120 using a training data set including physiological data of a driver while the vehicle 110 is in driving simulation mode and information on a status of the vehicle 110 while the vehicle 110 is in driving simulation mode. In one or more embodiments, the model may comprise a machine learning model. In one or more embodiments, the model may be a long-short term model.

Still referring to FIGS. 1A, 1B, 2, and 4, at step S411, the training data set may include physiological data of the driver of the vehicle 110 while the vehicle 110 is in driving simulation mode. The physiological data of the driver of the vehicle 110 may include temperature of the driver, electrocardiogram (ECG) data of the driver, galvanic skin response (GSR) data of the driver, face recognition data of the driver, iris recognition data of the driver, or combinations thereof.

Still referring to FIGS. 1A, 1B, 2, and 4, at step S412, the training data set may include information on a status of the vehicle 110 while the vehicle 110 is in driving simulation mode. The status of the vehicle 110 may include a status of throttle of the vehicle 110, a status of a brake of the vehicle 110, a velocity of the vehicle 110, an acceleration of the vehicle 110, the driving direction of the vehicle 110, environments, such as weather, road surface conditions, traffic signs, other surroundings of the vehicle 110, or combinations thereof.

Still referring to FIGS. 1A, 1B, 2, and 4, at step S420, physiological data of the driver of the vehicle 110 may be input to the model. The physiological data of the driver of the vehicle 110 may be obtained while the vehicle 110 is driving. The physiological data of the driver of the vehicle 110 may be obtained in real-time. The physiological data of the driver of the vehicle 110 may include temperature of the driver, electrocardiogram (ECG) data of the driver, galvanic skin response (GSR) data of the driver, face recognition data of the driver, iris recognition data of the driver, or combinations thereof. At step S420, the engine of the vehicle 110 turned on.

Still referring to FIGS. 1A, 1B, 2, and 4, at step S430, information on a status of the vehicle 110 may be input to the model. The status of the vehicle 110 may be obtained while the vehicle 110 is driving. The status of the vehicle 110 may be obtained in a real-time. The status of the vehicle 110 may include a status of throttle of the vehicle 110, a status of a brake of the vehicle 110, a velocity of the vehicle 110, an acceleration of the vehicle 110, the driving direction of the vehicle 110, environments, such as weather, road surface conditions, traffic signs, other surroundings of the vehicle 110, or combinations thereof. At step S430, the engine of the vehicle 110 turned on.

Still referring to FIGS. 1A, 1B, 2, and 4, at step S440, the controller may receive physiological data of the driver of the vehicle 110 while the vehicle 110 is in driving simulation mode, information on a status of the vehicle 110 while the vehicle 110 is in driving simulation mode, physiological data of the driver of the vehicle 110 while the vehicle 110 is driving, information on a status of the vehicle 110 while the vehicle 110 is driving, or combinations thereof, to predict a current preferred distance PD1.

Still referring to FIGS. 1A, 1B, 2, and 4, at step S450, the controller may obtain the current preferred distance PD1 by inputting the current physiological data of the driver of the vehicle 110, the current information on a status of the vehicle 110, or combinations thereof, to a machine learning model or a predictor.

Still referring to FIGS. 1A, 1B, 2, and 4, at step S460, the controller may monitor a preference of the driver of the vehicle 110, a current status of the driver of the vehicle 110, environment of the vehicle 110, status of surrounding vehicles of the vehicle 110, traffic around the vehicle 110, road condition around the vehicle 110, safety satisfaction requirement around the vehicle 110, or combinations thereof, to determine a current preferred distance PD1.

The controller may compare the current preferred distance PD1 to a predetermined distance. The controller may control the vehicle 110 to adjust a distance D1 between the vehicle 110 and the preceding vehicle 120 based on the current preferred distance PD1. In one or more embodiments, the vehicle 110 is controlled by adaptive cruise control, automatic cruise control, activating autonomous driving capabilities, or combinations thereof.

Still referring to FIGS. 1A, 1B, 2, and 4, at step S470, in response to determining that the current preferred distance PD1 between the vehicle 110 and the preceding vehicle 120 is less than the predetermined distance, the controller may generate an alarm to the driver of the vehicle 110. In some embodiments, the controller may generate an alarm on the display devices of the driver of the vehicle 110.

Still referring to FIGS. 1A, 1B, 2, and 4, at step S480, in response to determining that the current preferred distance PD1 between the vehicle and the preceding vehicle 120 is greater than or equal to the predetermined distance, the controller may control the vehicle 110 to maintain the current distance D1 between the vehicle 110 and the preceding vehicle 120.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system comprising:
a controller configured to:
train a model for predicting a preferred distance between a vehicle and a preceding vehicle using a training data set including physiological data of a driver and information on a status of the vehicle;
input current physiological data of the driver and information on a current status of the vehicle to the trained model to obtain a current preferred distance; and
control the vehicle to adjust a distance between the vehicle and the preceding vehicle based on the current preferred distance.

2. The system according to claim 1, wherein the physiological data of a driver comprises temperature of the driver, electrocardiogram (ECG) data of the driver, galvanic skin response (GSR) data of the driver, face recognition data of the driver, iris recognition data of the driver, or combinations thereof.

3. The system according to claim 1, wherein the status of the vehicle comprises a status of a throttle of the vehicle, a status of a brake of the vehicle, a velocity of the vehicle, an acceleration of the vehicle, a direction of the vehicle, or combinations thereof.

4. The system according to claim 1, wherein the controller is further configured to:
compare the current preferred distance to a predetermined distance.

5. The system according to claim 4, wherein the controller is further configured to:
generate an alarm to the driver in response to determining that the current preferred distance between the vehicle and the preceding vehicle is less than the predetermined distance.

6. The system according to claim 4, wherein the controller is further configured to:
control the vehicle to increase the distance between the vehicle and the preceding vehicle greater than or equal to the predetermined distance in response to determining that the current preferred distance between the vehicle and the preceding vehicle is less than the predetermined distance.

7. The system according to claim 4, wherein the controller is further configured to:
control the vehicle to maintain the distance between the vehicle and the preceding vehicle in response to determining that the current preferred distance between the vehicle and the preceding vehicle is greater than or equal to the predetermined distance.

8. The system according to claim 1, wherein the controller is further configured to:
display the current preferred distance between the vehicle and the preceding vehicle and a current distance between the vehicle and the preceding vehicle to the driver.

9. The system according to claim 1, wherein the vehicle is controlled by adaptive cruise control, automatic cruise control, activating autonomous driving capabilities, or combinations thereof.

10. The system according to claim 1, wherein the model is trained when an engine of the vehicle turned off.

11. The system according to claim 1, wherein the model is a long-short term model.

12. A method comprising:
training a model for predicting a preferred distance between a vehicle and a preceding vehicle using a training data set including physiological data of a driver and information on a status of the vehicle;
inputting current physiological data of the driver and information on a current status of the vehicle to the trained model to obtain a current preferred distance; and
controlling the vehicle to adjust a distance between the vehicle and the preceding vehicle based on the current preferred distance.

13. The method according to claim 12, wherein the physiological data of a driver comprises temperature of the driver, electrocardiogram (ECG) data of the driver, galvanic skin response (GSR) data of the driver, face recognition data of the driver, iris recognition data of the driver, or combinations thereof.

14. The method according to claim 12, wherein the status of the vehicle comprises a status of a throttle of the vehicle, a status of a brake of the vehicle, a velocity of the vehicle, an acceleration of the vehicle, a direction of the vehicle, or combinations thereof.

15. The method according to claim 12, further comprising:
comparing the current preferred distance to a predetermined distance.

16. The method according to claim 15, further comprising:
generating an alarm to the driver in response to determining that the current preferred distance between the vehicle and the preceding vehicle is less than the predetermined distance.

17. The method according to claim 15, further comprising:
controlling the vehicle to increase the distance between the vehicle and the preceding vehicle greater than or equal to the predetermined distance in response to determining that the current preferred distance between the vehicle and the preceding vehicle is less than the predetermined distance.

18. The method according to claim 15, further comprising:
controlling the vehicle to maintain the distance between the vehicle and the preceding vehicle in response to determining that the current preferred distance between the vehicle and the preceding vehicle is greater than or equal to the predetermined distance.

19. The method according to claim 12, further comprising:
displaying the current preferred distance between the vehicle and the preceding vehicle and a current distance between the vehicle and the preceding vehicle to the driver.

20. The method according to claim 12, wherein the vehicle is controlled by adaptive cruise control, automatic cruise control, activating autonomous driving capabilities, or combinations thereof.
